(19) United States
(12) Patent Application Publication
(10) Pub. No.: US 2019/0315906 A1
(43) Pub. Date: Oct. 17, 2019

(54) DISULFIDE-CONTAINING SELF-HEALING POLYMER BLEND

(71) Applicant: REPSOL, S.A., Madrid (ES)

(72) Inventors: Luis Miguel MÉNDEZ LLATAS, Madrid (ES); María Joaquina CABALLERO PÉREZ, Madrid (ES); María Victoria ALONSO ZORZO, Madrid (ES); Gary STEVENS, Surrey Guildford (GB); Ian GERMAN, Surrey Guildford (GB); Susmit BASU, Surrey Guildford (GB); Rhys RODES, Surrey Guildford (GB)

(21) Appl. No.: 16/468,708

(22) PCT Filed: Dec. 12, 2017
(86) PCT No.: PCT/EP2017/082489

§ 371 Date: Jun. 12, 2019

(30) Foreign Application Priority Data
Dec. 13, 2016 (EP) 16382597.9

(51) Int. Cl. C08G 18/38; C08L 23/08; C08L 75/02; C08K 5/372; C08G 18/76; C08G 18/48

(52) U.S. Cl. CPC C08G 18/3868; C08L 23/0853; C08L 75/02; C08L 2203/18; C08G 18/7621; C08G 18/4825; C08K 5/372

(57) ABSTRACT

The present invention refers to a polymer blend comprising (i) between 10 wt % and 99.9 wt %, with respect to the total weight of the blend, of a thermoplastic host polymer, provided it is not a polyborosiloxane; and (ii) between 0.1 wt % and 90 wt %, with respect to the total weight of the blend, of a disulfide-containing self-healing polymer comprising a first polymeric chain fragment comprising one or more disulfide moieties and at least one moiety selected from the group consisting of —N(R¹)—C(═O)—N(R²)—, —N(R¹)—C(═O)—O— and —N(R¹)—C(═O)—S—, wherein each R¹ and R² is independently selected from the group consisting of hydrogen, C₁-C₂₄-alkyl and C₆-C₁₅-aryl. The invention also refers to use of said blends, for example as cable sheaths.

### TECHNICAL FIELD

The disclosure relates to self-healing polymer blends, to their preparation and to the use thereof.

### BACKGROUND

Damage to polymers can be caused at various points in the life cycle from manufacture of different products, installation and operation. Relatively minor defects in polymeric products, such as scratches, small cuts and puncture damage can compromise their physical integrity and lead to failures. This can be especially relevant in polymers used as protective layers in order to prevent deterioration of the interior or contact with external elements, such as water.

In order to reduce failure rates, a growing interest exists in the design of self-healing materials in the field of polymer chemistry which have a variety of industrial applications. Self-healing materials may have applications in tubes, protection surfaces in general, tyres, all kinds of leak-tight structures (e.g. fuel tanks), packaging, films, different types of vessels, insulation, coatings and layers (e.g. electrical cables, optical fibre cables), all within a wide range of industries, including, automotive, marine, construction and/or aerospace and energy industries. Effective self-healing materials would increase the life of products and significantly reduce related maintenance expenditure for asset owners and operators.

Two general strategies have been used. A first strategy provides a polymer which is self-healing and substitutes the original material with a repair material. A second strategy uses additives to impart self-healing properties to the original material. Each strategy faces different challenges. When the objective is to completely substitute the original material, the self-healing polymer must have similar physical and chemical properties to the original material in order to exercise its function properly.

When the aim is to confer auto-repair properties to a host polymer by adding a self-healing agent, a balance is required between sufficient self-healing properties and maintenance of the physical and chemical properties of the host polymer (or at least up to an acceptable level). Before that balance can be accurately assessed however, other issues must be solved, for example, providing additives which are compatible with the host polymer.

Following the first strategy we can find in the prior art documents such as U.S. Pat. No. 3,905,944, WO2010/128007, WO2015/127981, CN105482065 or CN105669932, which concentrate on providing self-healing polymers based on disulfides. These polymers are not mixed with other polymeric materials but are alternative or substitute materials.

U.S. Pat. No. 3,905,944 discloses a polymer prepared by first reacting polytetramethylene ether glycol and a polyester derived from caprolactone and butanediol with cyclohexane-bis-(4-methylisocyanate) to provide a prepolymer, which is then reacted with 4,4′-diaminodiphenyl disulfide. No self-healing properties are reported.

WO2015/127981 discloses similar polymers of formula (I) and discloses their self-healing properties, wherein, as in the case of U.S. Pat. No. 3,905,944, the disulfide is an aromatic disulfide derived from 4,4′-diaminodiphenyl disulfide.

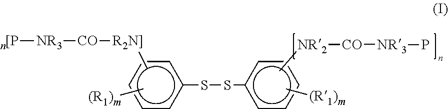

Both, CN105482065 or CN105669932, disclose similar polyurethane/polyether polymers comprising disulfide molecules. In both documents, contrary to the disclosures of U.S. Pat. No. 3,905,944 and WO2015/127981, the disulfide moieties are aliphatic disulfides derived from 2-hydroxyethyl disulfide.

Odriozola, I.; Azcune, I, European Polymer Journal, 2016, 84, 147-160 discloses a combination of two self-healing polymers, namely, the aromatic disulfides disclosed in WO2015/127981 and silicone putty (Si-putty), a polyborosiloxane having hydroxyl-terminated linear poly(dimethylsiloxane) dynamically crosslinked through borate esters, which has also a self-healing nature due to its reversible bonds. The authors report the compatibility of both due to the dynamic nature of the disulfide groups and the borates, respectively, which form dynamically interlocked structures similar to “Chinese rings”. The document does not mention any self-healing properties of the mixture, but investigates other mechanical properties.

WO2010/128007 discloses self-healing polymers based on a thiocarbamate backbone and disulfide functional groups.

Following the second strategy mentioned above, other disclosures, such as CN104610587A, US20080173382 or WO2015181054, seek to impart self-healing properties to polymers by use of different additives. CN104610587A discloses a rubber material mixed with small molecule sulfide-containing molecules. US20080173382 discloses also a rubber material mixed with a healing agent 20 which can be a sulfur containing compound. Polymeric polysulfides are generically mentioned. WO2015181054 discloses a thermoset epoxy composite comprising reinforcement fiber and an epoxy resin mixed with small molecule aromatic disulfides, namely bis(4-aminophenyl)disulfide.

### BRIEF DESCRIPTION OF THE DRAWINGS

FIG. 1: water barrier test apparatus (see example 5 below).

FIG. 2: actual water barrier apparatus sample chamber, loaded with a test specimen (see example 5 below).

FIG. 3: Schematic representation of the apparatus used for measuring water barrier ability of test samples (see example 5 below).

FIG. 4: Top view of an actual apparatus used for measuring water barrier ability of test samples (see example 5 below).

FIGS. 5A, 5B, 5C and 5D: Cut-and-heal test (see example 4 below).

### BRIEF SUMMARY

In order to solve the above mentioned problems, the present disclosure provides a blend, preferably a thermoplastic blend, comprising
(i) between 10 wt % and 99.9 wt %, with respect to the total weight of the blend, of a thermoplastic host polymer, provided it is not a polyborosiloxane, or, more generally, provided it is not a polymer comprising dynamic borate esters bonds (that is, a thermoplastic host polymer having no borate esters groups, such as silicone putty).; and
(ii) between 0.1 wt % and 90 wt %, with respect to the total weight of the blend, of a disulfide-containing self-healing polymer comprising a first polymeric chain fragment comprising one or more disulfide moieties and at least one moiety selected from the group consisting of —N(R¹)—C(═O)—N(R²)—, —N(R¹)—C(═O)—O— and —N(R¹)—C(═O)—S—, wherein each R¹ and R² is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

Said blend, in the following “blend of the disclosure” or “blend according to the disclosure”, is therefore a first aspect of the present disclosure. A second aspect of the disclosure is a method for the preparation of said blends comprising mixing said thermoplastic host polymer (also referred to in the following as “component (i)”) and said disulfide-containing self-healing polymer (also referred to in the following as “disulfide-containing self-healing polymers used in the blend of the disclosure” or simply as “component (ii)”). A third aspect of the disclosure is an article, for example, a tube, a protection surface, a tyre, a package, a leak-tight article, a film, a coating or layer (e.g. electrical cables, optical fibre cables, cable sheaths), comprising the blend of the disclosure. A fourth aspect of the disclosure is the use of a blend according to the disclosure as a self-healing polymer.

Contrary to the prior art strategy seeking to find a self-healing polymer that would replace those currently used, the inventors have here devised a polymer blend solution wherein the self-healing polymer is added to a thermoplastic host polymer which already has the required mechanical properties. The result is a blend with an excellent balance between self-healing behavior and mechanical properties. It is remarkable that all blends of the disclosure provided water barrier function, in many cases even at room temperature immediately after puncture. It is already known that disulfide-containing polymers can display self-healing properties, but it is surprising that the disulfide-containing self-healing polymers used in the blends of the disclosure are readily compatible with other host polymers and that even small amounts of disulfide-containing self-healing polymers demonstrate very rapid self-healing abilities even at ambient temperatures in many of the examples.

To the best of our knowledge none of the documents in the prior art disclose mixtures of thermoplastic host polymers (component (i)) with disulfide-containing self-healing polymers comprising a first polymeric chain fragment comprising one or more disulfide moieties and at least one moiety selected from the group consisting of polyurethanes, polycarbamates and polythiocarbamates (component ii). Not only have the inventors found that both types of polymers are surprisingly compatible, but also that, even low loadings of component (ii) remarkably impart self-healing properties, while maintaining the mechanical properties of the blends of the disclosure within acceptable levels for applications, such as cable sheaths. Not even Odriozola, I.; Azcune, I, European Polymer Journal, 2016, 84, 147-160 could have suggested that (a) the disulfide-containing self-healing polymers used in the present disclosure (component (ii)) could provide self-healing mixtures when combined with thermoplastics (component (i)) that are not self-healing per se; or (b) that they could provide compatible mixtures which could be processed. According to Odriozola et al, compatibility was derived from the dynamic nature of the disulfide groups and the borates present in both components of the composition (“Chinese rings”). It has thus been surprising that polymers different from polyborosiloxanes, i.e. having no such borates, were still capable of forming compatible blends with the disulfide-containing self-healing polymers used in the present disclosure.

A further surprising benefit is the fact that the blend of the disclosure results in an improvement of the resistance to puncture with respect to the pure thermoplastic host polymer (component (i)). That is, not only does the present disclosure provide an appropriate balance between the original properties of the thermoplastic host polymer and a self-healing behavior, but the properties of the polymer are even improved. This is a totally unexpected result which could not have been anticipated. The fact that the resistance to puncture of the disulfide-containing self-healing polymers used in the blend of the disclosure is typically much lower than that of the thermoplastic host polymer, indicates an unexpected synergistic technical effect (toughening effect). This result is significant as it means that a low-cost solution to reinforcement, leading to fewer damage events with resulting defects can be envisaged.

### DETAILED DESCRIPTION

### Definitions

The use of a singular noun or pronoun when used with the term “comprising” in the present disclosure means “one”, including “one or more”, “at least one”, and “one or more than one”.

The terms “comprise”, “have”, and “include” are open-ended linking verbs. One or more forms of these verbs such as “comprise”, “which comprise”, “have”, “which have”, “include”, “which include” are also open-ended. For example, any methods, which “comprise”, “have”, or “include” one or more steps, are not limited to possessing only the one or those more steps, but also cover further unidentified steps.

Throughout the present disclosure weight percentage (“wt %”) is 100 times the relation in weight (e.g. in grams or kilograms) between the component specified and the total weight of the blend in the same units. Unless otherwise indicated, “wt %” refers to the total weight percentage of a given component with respect to the total weight of the blend of the disclosure.

“Thermoplastic” refers to a polymer which is capable of being melt processed. Thermoplastic polymers undergo melting to a free flowing liquid above the polymer melting point (or melt temperature range). Once cooled, they return to a solid state. Due to their ease of melt phase processing, maleability and other mechanical properties, these polymers are widely used in industry. They typically comprise a crystalline phase and an amorphous phase.

“Self-healing” has the normal meaning provided in the art and refers to the property by which a polymer totally or partially recovers its structure and properties after suffering damage, thereby recovering its physical integrity totally or partially. This self-healing occurs due the presence of dynamic bonds that can recover by themselves after being broken.

“Blend” refers to material wherein two or more components form a mixture that is stable (for example, for more than 1 hour, or more than 1 day). The blends of the disclosure are preferably homogeneous, that is, mixtures wherein components are undistinguishable to the naked eye and present consistent physical and chemical properties throughout the sample. The blends of the disclosure can therefore be prepared by mixing component (i) with component (ii), and can be used as such, without further processing, or it can be submitted to further modifications, such as crosslinking. Also, the present disclosure does not exclude the possibility of different components of the blend spontaneously undergoing some degree of crosslinking.

“Polymer” or “polymeric” has the common meaning as understood by the skilled person in the field of chemistry, for example, as defined in many textbooks, such as “Polymer Science & Technology”, third edition, Fried, J. R., Prentice Hall. It refers to a material made of one or more repeating units (monomers), which react (polymerize) resulting in a long chain molecule. Polymers generally include but are not limited to, homopolymers (made of a monomer having identical structure), copolymers (made of two or more monomers having different structures), such as for example, block, graft, random and alternating copolymers, terpolymers, etc. Furthermore, unless otherwise specifically limited, the term “polymer” includes all possible spatial configurations of the molecule. These configurations include, but are not limited to isotactic, syndiotactic and random symmetries. Throughout the present disclosure reference is made to “polymeric chain fragment”, and refers to a part of the molecule made of a given polymer, and which is attached to the rest of the molecule through one or more covalent bonds. For example, the disulfide-containing self-healing polymers used in blend of the disclosure can comprise different parts, including a polyalkylene moiety (polymeric chain fragment), which itself can be attached to a disulfide fragment through a urethane, carbamate and thiocarbamate functional group.

“Disulfide” (or “disulphide”) is the R^{a}—S—S—R^{a} moiety, wherein R^{a} is an organic residue, typically a C₆-C₁₅-aryl, C₆-C₁₅-heterocyclyl or C₁-C₂₄-alkyl.

“Aryl” refers to an aromatic hydrocarbon group having the number of carbon atoms indicated in each case, such as phenyl or naphthyl.

“Alkyl” refers to a straight or branched hydrocarbon chain group consisting of carbon and hydrogen atoms, containing no unsaturation, having the number of carbon atoms indicated in each case, which is attached to the rest of the molecule by a single bond. The skilled person can use in each case different alkyl groups, for example, containing 1 to 24, 1 to 12 or 1 to 6 carbon atoms. Exemplary alkyl groups can be methyl, ethyl, n-propyl, i-propyl, n-butyl, t-butyl, n-pentyl, etc.

“Cycloalkyl” refers to a saturated carbocyclic ring having the number of carbon atoms indicated in each case. Suitable cycloalkyl groups include, but are not limited to cycloalkyl groups such as cyclopropyl, cyclobutyl, cyclopentyl or cyclohexyl.

“Cycloalkyl-alkyl” refers to a cycloalkyl group as defined above attached to the rest of the molecule through an alkyl group, and having the number of atoms indicated in each case. For example, C₃-C₂₄-cycloalkyl-C₁-C₂₄-alkyl should be understood as a moiety comprising a cycloalkyl having 3 to 24 carbon atoms attached to the rest of the molecule through an alkyl group having 1 to 24 carbon atoms. Exemplary cycloalkyl-alkyl moieties are 2-cyclopentylethyl or cyclopropylmethyl.

“Heterocyclyl” refers to a stable ring which consists of the number of carbon atoms indicated in each case and from one to five heteroatoms selected from the group consisting of nitrogen, oxygen, and sulphur, preferably a 4-to 8-membered ring with one or more heteroatoms, more preferably a 5- or 6-membered ring with one or more heteroatoms. For the purposes of this disclosure, the heterocycle may be a monocyclic, bicyclic or tricyclic ring system, which may include fused ring systems; and the nitrogen, carbon or sulfur atoms in the heterocyclyl group may be optionally oxidised; the nitrogen atom may be optionally quaternized; and the heterocyclyl group may be partially or fully saturated or aromatic, in which case it is considered an heteroaryl group. Examples of such heterocycles include, but are not limited to, azepines, benzimidazole, benzothiazole, furan, isothiazole, imidazole, indole, piperidine, piperazine, purine, quinoline, thiadiazole, tetrahydrofuran.

“arylalkyl” refers to an aryl group linked to the rest of the molecule through an alkyl group, and having the number of atoms indicated in each case. For example, C₆-C₁₅-aryl-C₁-C₂₄-alkyl should be understood as a moiety comprising an aryl group having 6 to 15 carbon atoms attached to the rest of the molecule through an alkyl group having 1 to 24 carbon atoms. Exemplary arylalkyl moieties are benzyl and phenethyl.

“Polyalkylene glycol” refers to an organic residue comprising the repetitive ether units (—O-alkyl-). They are typically prepared by polymerization of cyclic oxide units (e.g. ethylene oxide, propylene oxide, THF), and are available from many vendors in different forms and molecular weights.

Thermoplastic Host Polymer

The inventors have proven that the specific family of disulfide-containing self-healing polymers used in the blends of the disclosure (component (ii)) are compatible with a wide range of thermoplastic host polymers (also known as “base polymers” or “matrix polymers”), or mixtures of thermoplastic host polymers. Stable and well mixed blends were prepared with different grades of polyethylenes, including grafted polymers, ethylene vinyl acetates (EVA), or ethylene butyl acrylate (EBA). Also, mixtures of different thermoplastic polymers, e.g. EVA and high-density polyethylene, have proven compatibility with disulfide-containing self-healing polymers, optionally using small amounts of compatibilizers, if appropriate. This is a key precondition for obtaining products that are suitable for commercial applications. At the same time, other physical and/or chemical properties were retained, or at least not significantly affected. Although we do not wish to be bound by theory, it is believed that the thermoplastic host polymer does not participate in the self-healing process and the self-healing network may be independent of thermoplastic host polymer used. Thus, the host polymer used in the blend of the disclosure is typically one containing no groups capable of self-healing. In a preferred embodiment the thermoplastic polymer is semi-crystalline.

Thus, the skilled person can select from a wide range of thermoplastic host polymers or mixtures thereof (different to the disulfide-containing self-healing polymer (component (ii))) in order to prepare the blends of the disclosure. For example, said component (i) can be a thermoplastic host polymer resulting from the polymerization of at least one double-bond containing monomer.

Non-limiting examples include thermoplastic polymers such as polyolefins (also known as polyalkylenes), polyalkylene glycols, polystyrenes, fluoropolymers (e.g. polytetrafluoroethylene), polyvinyl chlorides, polycarbonates, polybenzimidazoles, polyamides, polylactic acid, rubbers, (meth)acrylates or copolymers thereof, as well as mixtures thereof. Thermoplastic host polymers which are preferred are polyolefins (i.e. derived from the polymerization of a hydrocarbon comprising one double bond), polyvinyl chloride and copolymers thereof. Copolymers of polyolefins include, but are not limited to, those using monomers of vinyl esters or (meth)acrylates or (meth)acrylic acid. Said polyolefins can be, for example, polyethylene (PE), whether or not grafted, linear low-density polyethylene (LLDPE), low-density polyethylene (LDPE), high-density polyethylene (HDPE), or polypropylene. Polyolefins can be grafted with a wide range of groups, such as maleic anhydride (MAH), (meth)acrylates, silanes and any group which is polymerizable under the same conditions as the polyolefin. Further preferred copolymers of polyolefins are copolymers formed by copolymerization of a hydrocarbon comprising one double bond and vinyl esters, such as vinyl acetate. The most representative polymers of this family are the polyethylene vinyl acetate (EVA). Also, the copolymers of a hydrocarbon comprising one double bond and a (meth)acrylate can be used as the polymer (component (i)). Examples of copolymers of a hydrocarbon comprising one double bond and a (meth)acrylate ester or acid are copolymers of a hydrocarbon comprising one double bond and acrylic acid or esters of (meth)acrylate (C₁-C₂₂ alkyl esters, e.g. methylmethacrylate) or acrylonitrile. Some exemplary acrylate esters or acids are methyl (meth)acrylate, ethyl (meth)acrylate, 2-ethylhexyl (meth)acrylate, hexyl (meth)acrylate, 2-ethylbenzyl acrylate, lauryl acrylate, cetyl acrylate, stearyl acrylate, eicosyl acrylate, isodecyl acrylate, dodecyl (meth)acrylate, hydroxyethyl (meth)acrylate, 2-ethoxyethyl (meth)acrylate, butyl (meth)acrylate or trimethylolpropane triacrylate (TMPTA), benzyl acrylate, cyanoethyl acrylate, 2,2,2-trifluoroethyl (meth)acrylate. Exemplary polymers of this class are thus ethylene methyl acrylate (EMA), ethylene methyl methacrylate (EMMA), ethylene butyl acrylate (EBA), ethylene acrylic acid (EEA). It is preferable that the blend of the disclosure is itself thermoplastic.

The thermoplastic polymers can be grafted with one or more groups which improve their compatibility with the disulphide-containing self-healing polymer, such as maleic anhydride.

Disulfide-Containing Self-Healing Polymers Used in the Blends of the Disclosure

Preparation

Component (ii) comprises a first polymeric chain fragment comprising one or more disulfide moieties and at least one moiety selected from the group consisting of —N(R¹)—C(═O)—N(R²)—, —N(R¹)—C(═O)—O— and —N(R¹)—C(═O)—S—, wherein each R¹ and R² is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl. The disulfide-containing self-healing polymers used in the blend of the disclosure have shown a surprisingly good compatibility with polymers, to which they impart self-healing properties, and even improve their mechanical properties. This is surprising also in view of the behavior of said component (ii) within the mixture. As already mentioned above, the self-healing polymer seems to work independently from the thermoplastic host polymer network. It is preferable that the component (ii) is also a thermoplastic polymer.

They can be prepared following methods described in the art, for example, as described in U.S. Pat. No. 3,905,944, WO2010/128007, CN105482065, CN105669932 or WO2015/127981. It typically involves the reaction of a disulfide moiety comprising at least two active hydrogen-containing groups (e.g. amine, alcohol, or thiol) with a polymeric polyisocyanate, to produce the corresponding polyurethanes, polycarbamates and polythiocarbamates (i.e. R¹ and R² is hydrogen). In order to obtain groups wherein R¹ or R² are different from hydrogen, said hydrogen can be subsequently replaced, following known procedures, to obtain the corresponding groups-N(R¹)—C(═O)—N(R²)—, —N(R¹)—C(═O)—O— and —N(R¹)—C(═O)—S— groups, wherein each R¹ and R² is independently selected from the group consisting of C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl. Depending on the number of active hydrogen-containing groups (e.g. amine, alcohol, or thiol) present in the disulfide moiety, the resulting intermediate will be linear (two active hydrogen containing groups) or branched (more than two active hydrogen containing groups, namely, three or four).

The conditions to produce these polyurethanes, polycarbamates and polythiocarbamates are well known in the art, and involve contacting both components, probably requiring the use of a solvent and heat. See for example the chapter dedicated to polyurethanes in “Ullmann's Encyclopedia of Industrial Chemistry”, seventh edition, 2005 by Wiley-VCH Verlag GmbH & Co. KGaA or in “Chemistry and Technology or Polyols for Polyurethanes” by Mihail Ionescu, Rapra technology, 2005. Said polymeric polyisocyanate can be additionally grafted into a second polymeric chain fragment such as, for example, a polyvinyl alcohol.

The polymeric polyisocyanate can be prepared by reacting a polyisocyanate having a low molecular weight with a polymer comprising at least one active hydrogen-containing group, preferably 2 or more, for example comprising at least one amine, hydroxyl or thiol group, or a mixture thereof. There are a number of such polymers available to the skilled person. Examples may be selected from the group consisting of polyalkylene glycols, formaldehyde phenolic resins, celluloses, polyhydroxystyrenes, polyvinyl alcohol, polyesters, polyamides, polycarbonates, polyolefins, and copolymers and terpolymers of their constituent monomers. Preferred polymers comprising at least one active hydrogen-containing group are polyalkylene glycols having two or more active hydrogen-containing groups, for example comprising at least two amine, hydroxyl or thiol groups (or mixtures thereof), for example, polytetramethylene glycol (PTMG), polypropylene glycol (PPG), polyethylene glycol (PEG), poly(ethylene glycol) diamine, poly(propylene glycol) diamine, poly(ethylene glycol) dithiol, pentaerythritol tetrakis(3-mercaptopropionate), pentaerythritol tetrakis(3-mercaptopropionate) or mixtures thereof. For example, different mixtures of poly(ethylene-co-propylene) glycols are commercially available, such as Poly(propylene glycol)-block-poly(ethylene glycol)-block-poly(propylene glycol) or Poly(propylene glycol)-block-poly(ethylene glycol). Excellent results have been obtained with polyalkylene glycols comprising two active hydrogen-containing groups, such as polypropylene glycol (PPG), polyethylene glycol (PEG), poly(ethylene glycol) diamine, or poly(propylene glycol) diamine, and which have the additional advantage of being available in a wide variety of grades and molecular weights.

Other polyalkylene glycols can be prepared or obtained from different vendors, and the skilled person can choose those having different properties for specific applications. For example, it is possible to use polyalkylene glycols comprising more than two, e.g three or four, active hydrogen-containing groups, such as pentaerythritol tetrakis(3-mercaptopropionate). The resulting product is branched, for example, as reflected in disulfide-containing self-healing polymers of formula (I), (II) or (III) when y is 2, 3 or 4 (described below in the present disclosure). Another source of branching in the disulfide-containing self-healing polymers used in the blends of the disclosure is the use of a sulfide moiety comprising more than two, namely, three or four, active hydrogen-containing groups. See below compounds of formula (A) wherein the sum of v and/or w is three or four, or more.

For example, polyalkylene glycols can be used having different molecular weights, e.g. from 100 to 20,000 Da, or form 200 to 10,000 Da or from 250 to 5,000 Da, typically between 300 and 4,000 Da.

The polyisocyanate having a low molecular weight can be any comprising two or more isocyanate groups. A large number of such molecules are known to the skilled person. The present disclosure is not limited to a particular polyisocyanate having a low molecular weight, and it can be aliphatic or aromatic, preferably aromatic. Just to mention a few examples, polyisocyanates having a low molecular weight suitable in the present disclosure can be a disiocyanate selected from the group consisting of isophorone diisocyanate (IPDI), 4,4′-methylene diphenyl diisocyanate (MDI), toluene 2,4-diisocyanate (TDI), 1,4-tetramethylenediisocyanate, 1,6-hexamethylenediisocyanate (HDI), 1,10-decamethylenediisocyanate, 1,5-naphthalenediisocyanate, cumene2,4-diisocyanate, 4-methoxy-1,3-phenylenediisocyanate; 4-chloro-1,3-phenylenediisocyanate, 4-bromo-1,3-phenylenediisocyanate, 4-ethoxy-1,3-phenylenediisocyanate, 2,4-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediiisocyanate, 9,10-anthracenediisocyanate, 4,4-diisocyanatodibenzyl, 3,3′-dimethyl-4,4-diisocyanatodiphenylmethane, 2,6-diisocyanatostilbene, 3,3-dimethyl-4,4-diisocyanatodiphenyl, 3,3-dimethoxy-4,4′-diisocyanatodiphenyl, 1,4-anthracenediisocyanate, 2,5-fluorenediisocyanate, 1,5-naphthalenediisocyanate, 1,3-phenylenediisocyanate, 1,4-phenylenediisocyanate, 1,3-tolylenediisocyanate 2,6-diisocyanatobenzfuran, and a triisocyanate (e.g. 2,4,6-toluenetriisocyanate or 2,4,4′-triisocyanatodiphenylether).

The above procedures can be used to prepare any of the disulfide-containing self-healing polymers used in the blends of the disclosure, including those of formula (I) or formula (II), formula (I-a) or formula (II-a), as well as those disulfide-containing self-healing polymers comprising at least one residue of formula (III) or of formula (III-a), or the disulfide-containing self-healing polymers of formula (IV-a), formula (V-a), formula (VI-a) or formula (VII-a) all of which are defined below.

For example, following the above general procedure, a disulfide-containing self-healing polymer that comprises at least one residue of formula (III) or (III-a) as defined further below in the present disclosure can be prepared by reacting a compound of formula (A) with a compound of formula (B) or with a compound of formula (C):

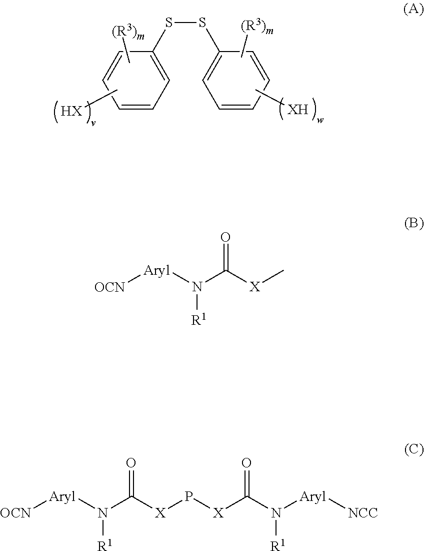

wherein Aryl, R¹, X, P, R³ and m have the meanings already described elsewhere in the present disclosure, and each of v and w is 1, 2, 3 or 4, preferable 1 or 2.

Note that the skilled person can prepare alternative disulfide-containing compounds to those of formula (A) by changing some of the groups. For example, the benzene rings in compound (A) can be substituted by other aromatic or heteroaromatic moieties, such as naphthalene or furane.

The compounds of formula (B) and (C) can be prepared by reacting a diisocyanate of formula (D) with a polymer of formula (E), wherein X and y have the meanings described elsewhere in the present disclosure.

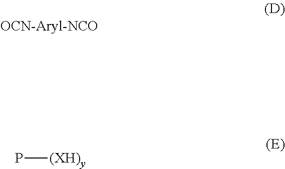

Thus, for example, X can be selected from —O, —S— and —N(H)—, preferably, —N(H)—, and y can be 1, 2, 3 or 4.

Following an analogous strategy, the compounds of formula (IV-a) can be prepared by reacting a compound (A) as described above with a compound of formula (B) or of formula (C) wherein P is a polyalkylene glycol (PAG), such as those mentioned elsewhere in the present disclosure, for example polypropylene glycol (PPG), polyethylene glycol (PEG), poly(ethylene glycol) diamine, poly(propylene glycol) diamine or mixtures thereof. Analogously, said compounds of formula (B) and (C) can be prepared by reaction of a diisocyanate of formula (D) with a polymer of formula (E), wherein P is a polyalkylene glycol with y groups of formula XH, wherein y is 1, 2, 3 or 4. Compounds of formula (V-a) can be obtained by choosing compounds of formula (A), (B) an (C) with appropriate substituents in X and R¹ (hydrogen).

Similar strategies provide compounds of formula (VII-a). According to an embodiment of the disclosure, a diisocyanate of formula (D) can be reacted with a second polymeric chain fragment Ps, for example, one selected from the group consisting of poly(vinyl alcohol), poly(vinyl amine), poly(vinyl imidazole), polyhydroxystyrene, (meth)acrylate and copolymers thereof with alpha-olefins. In an embodiment of the disclosure Ps is a second polymeric chain fragment having one or more hydrogen containing active groups (—XH), for example, selected from polyvinyl alcohol or a copolymer thereof. The reaction produces the modified polymer of formula (F), which can be subsequently reacted with a polymer of formula (E), wherein y is 2, 3 or 4, preferably a polyalkylene glycol (PAG), to provide the polymer (G):

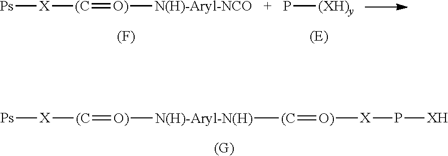

Polymer (G) can react with a further diisocyanate of formula (D) and then with a compound of formula (A) to provide the desired disulfide-containing self-healing polymer of formula (VII-a). Compounds of formula (VI-a) can be obtained by further substitution of the hydrogen atom of the —N(H)— groups of the polymer (G).

Disulfide-Containing Self-Healing Polymers

The disulfide-containing self-healing polymers can be thus prepared following different procedures. They can be classified as aliphatic or aromatic, i.e. those wherein the disulfide moiety is directly bonded to an aliphatic group and those in which it is directly bonded to an aromatic group. Examples of aliphatic disulfides that are commercially available are 2,2′-dithioethanol or 2-hydroxyethyl disulfide. Examples of aromatic disulfides that are commercially available are 4,4′-diaminodiphenyl disulfide, 2,2′-diaminodiphenyl disulfide, 2-amino-4-chlorophenyl disulfide, 4,4′-dithiobis(N-(2-hydroxy-1-naphthylmethylene)aniline), N,N-bis(2-hydroxybenzylidene)-4-aminophehyl disulfide, 4,4′-dithiodianiline bismaleimide, 4,4′-hydroxyphenyl disulfide, 4-(2-hydroxyethoxy)phenyl disulfide, bis(4-glycidyloxyphenyl)disulfide, or mixture thereof. According to a preferred embodiment the disulfide-containing self-healing polymer used in the disclosure is an aromatic disulfide, preferably a diaminophenyl disulfide.

The skilled person can choose from different first polymeric chain fragments, for example, polyalkylene glycols, formaldehyde phenolic resins, celluloses, polyhydroxystyrenes, polyvinyl alcohol or copolymers thereof. Said first polymeric chain fragments are preferably linear polymers comprising two active hydrogen-containing groups (e.g. amine, alcohol, or thiol). Polyalkylene glycols have been found useful for their good results, and also because they can be easily produced or acquired in a wide range of molecular weights, allowing the fine tuning of the properties of the disulfide-containing self-healing polymer used in the disclosure. Non-limiting examples of polyalkylene glycols are polypropylene glycols, polyethylene glycols, poly(ethylene glycol) diamines, poly(propylene glycol) diamines or a mixture thereof.

The disulfide-containing self-healing polymer used in the disclosure comprises at least one moiety selected from the group consisting of —N(R¹)—C(═O)—N(R²)—, —N(R¹)—C(═O)—O— and —N(R¹)—C(═O)—S—, wherein each R¹ and R² is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen. The disulfide-containing self-healing polymer used in the disclosure typically comprises a group —N(H)—C(═O)—N(H)—, which is the result of reacting an amine and a isocyanate group, typically providing a group wherein R¹ and R² are hydrogen. However, it is possible to totally or partially substitute these hydrogen atoms with R¹ and R², wherein each R¹ and R² is independently selected from the group consisting of C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl or C₆-C₁₅-aryl.

Said first polymeric chain fragment can be attached to a second polymeric chain fragment, preferably polyvinyl alcohol or a copolymer thereof. Accordingly, an embodiment of the disclosure is a blend wherein said disulfide-containing self-healing polymer comprises a fragment of the following formula (I) or is a polymer of formula (II)

(-[L¹-S—S-L¹]_{y}-U¹-)ₓ (I)

Ps-(L²-U¹-[L¹-S—S-L¹]_{y}-U¹-L²-)_{q}Ps (II)
wherein
   x is an integer representing 1 or more;
   q is an integer representing 1 or more;
   y is an integer representing 1, 2, 3 or 4;
   Ps is a polymeric chain, for example one selected from the group consisting of poly(vinyl alcohol), poly(vinyl amine), poly(vinyl imidazole), polyhydroxystyrene, (meth)acrylate and copolymers thereof with alpha-olefins, preferably polyvinyl alcohol or a copolymer thereof;
   each L¹ is independently an organic moiety comprising (a) one or more residues selected from the group consisting of —N(R¹)—C(═O)—N(R²)—, —N(R¹)—C(═O)—O— and —N(R¹)—C(═O)—S—, and (b) one or more of the following residues selected from the group consisting of C₆-C₁₅-aryl, C₆-C₁₅-heterocyclyl and C₁-C₂₄-alkyl;
   each U¹ is independently a polymer selected from the group consisting of polyalkylene glycols, poly (meth)acrylates, polyesters, polycaprolactones, and polyvinyl alcohol; each U¹ being linked to the same or different further U¹ units through y number of groups of formula [L¹-S—S-L¹]-, thus forming a linear (y=1) or branched (y=2, 3 or 4) polymer;
   each L² is independently an organic moiety comprising (a) one or more residues selected from the group consisting of —N(R¹)—C(═O)—N(R²)—, —N(R¹)—C(═O)—O— and —N(R¹)—C(═O)—S—, and (b) one or more of the following residues selected from the group consisting of aryl, heterocyclyl and alkyl;
      wherein each R¹ and R² are independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

Therefore, depending on the value of y, the compounds of formula (I) and (II) can be linear or branched. It is preferred that the value of y is 1 in the polymer of formula (I) or (II), i.e. a blend wherein said disulfide-containing self-healing polymer comprises a fragment of the following formula (I-a) or is a polymer of formula (II-a)

(-L¹-S—S-L¹-U¹)ₓ— (I-a)

Ps-(L²-U¹-L¹-S—S-L¹-U¹-L²)_{q}-Ps (II-a)
wherein
   x is an integer representing 1 or more;
   q is an integer representing 1 or more;
   Ps is a polymeric chain, for example, one selected from the group consisting of poly(vinyl alcohol), poly(vinyl amine), poly(vinyl imidazole), polyhydroxystyrene, (meth)acrylate and copolymers thereof with alpha-olefins, preferably polyvinyl alcohol or a copolymer thereof;
   each L¹ is independently an organic moiety comprising (a) one or more residues selected from the group consisting of —N(R¹)—C(═O)—N(R²)—, —N(R¹)—C(═O)—O— and —N(R¹)—C(═O)—S—, and (b) one or more of the following residues selected from the group consisting of C₆-C₁₅-aryl, C₆-C₁₅-heterocyclyl and C₁-C₂₄-alkyl;
   each U¹ is independently a polymer selected from the group consisting of polyalkylene glycols, poly (meth)acrylates, polyesters, polycaprolactones, and polyvinyl alcohol;
   each L² is independently an organic moiety comprising one or more residues selected from the group consisting of —N(R¹)—C(═O)—N(R²)—, —N(R¹)—C(═O)—O— and —N(R¹)—C(═O)—S—, and one or more of the following residues selected from the group consisting of aryl, heterocyclyl and alkyl;
      wherein each R¹ and R² are independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

Unless otherwise indicated, the first polymeric chain fragments labeled with an “-a” suffix, are linear chains.

As mentioned above, aromatic disulfides are preferred, and it is a further embodiment of the disclosure a blend wherein said disulfide-containing self-healing polymer (component (ii)) comprises at least one polymeric chain fragment of formula (III)

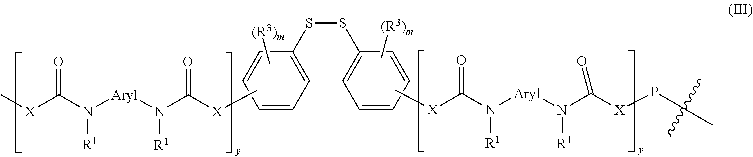

wherein
m can be 0, 1, 2, 3 or 4, preferably 0, 1 or 2, for example 0 or 1;
each y is independently selected from 1, 2, 3 or 4;
each R¹ is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
P is a polymeric chain fragment selected from the group consisting of polyalkylene glycols, formaldehyde phenolic resins, celluloses, polyhydroxystyrenes, polyvinyl alcohol or copolymers thereof; each P being linked to the same or different further P units through y number of groups, thus forming a linear (y=1) or branched (y=2, 3 or 4) polymer;
each X is independently selected from —O—, —O-alkyl-O, —S—, S-alkyl-S— or —N(R²)—, preferably —O—, —S—, or —N(R²)— wherein each R² is selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

The value of “y” is typically determined by the commercial product used, and is in most cases 1, but the skilled person can prepare derivatives with a higher number of “y”.

Preferred disulfide-containing self-healing polymers in the present disclosure are those wherein y is 1, for example a polymeric chain fragment of formula (III-a)

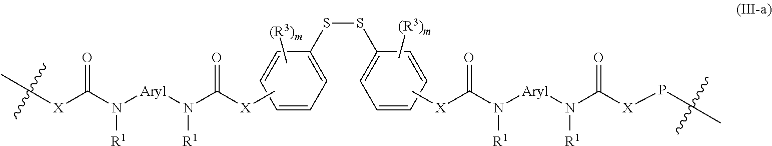

wherein
m can be 0, 1, 2, 3 or 4;
each R¹ is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
P is a polymeric chain fragment selected from the group consisting of polyalkylene glycols, formaldehyde phenolic resins, celluloses, polyhydroxystyrenes, polyvinyl alcohol or copolymers thereof;
each X is independently selected from —O—, —O-alkyl-O—, —S—, S-alkyl-S— or —N(R²)—, preferably —O—, —S— or —N(R²)—, wherein each R² is selected from the group consisting of hydrogen, C₁-C₂₄-alkyl, C₃-C₂₄-cycloalkyl, C₃-C₂₄-cycloalkyl C₁-C₂₄-alkyl, C₄-C₂₀-heterocyclyl, C₆-C₁₅-arylC₁-C₂₄-alkyl and C₆-C₁₅-aryl, preferably hydrogen.

It is a further embodiment of the disclosure a blend comprising a disulfide-containing self-healing polymer (component (ii)) comprising a polymeric chain fragment of formula (IV-a)

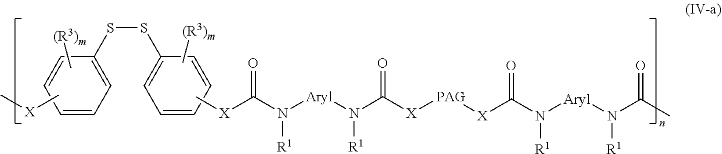

wherein
m can be 0, 1, 2, or 4;
n is 1 or more;
each R¹ is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
each X is independently selected from —O—, —O-alkyl-O—, —S—, S-alkyl-S— or —N(R²)—, preferably —O—, —S— or —N(R²)—, wherein each R² is selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen; and
PAG represents a polyalkylene glycol.

It is a further embodiment of the disclosure a blend comprising a disulfide-containing self-healing polymer (component (ii)) comprising a polymeric chain fragment of formula (V-a)

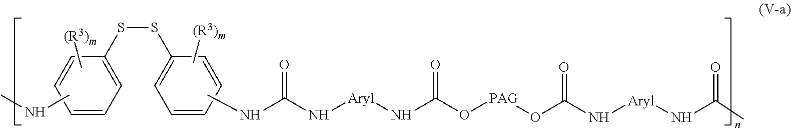

wherein
m can be 0, 1, 2, 3 or 4;
n is 1 or more;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl; and PAG represents a polyalkylene glycol.

As mentioned above, the disulfide-containing self-healing polymer used in the disclosure may comprise a second polymeric chain fragment, typically a polyvinyl alcohol. Accordingly, it is a further embodiment of the disclosure a blend comprising a disulfide-containing self-healing polymer (component (ii)) of formula (VI-a)

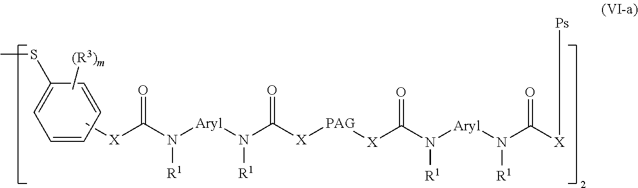

wherein
m can be 0, 1, 2, 3 or 4;
each R¹ is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
PAG represents a polyalkylene glycol;
each X is —O—, —O-alkyl-O—, —S—, —S-alkyl-S— or —N(R²)—, preferably —O—, —S— or —N(R²)—, wherein each R² is selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen; and
Ps represents a second polymeric chain fragment selected from polyvinyl alcohol or a copolymer thereof.

It is a further embodiment of the disclosure a blend comprising a disulfide-containing self-healing polymer (component (ii)) of formula (VII-a)

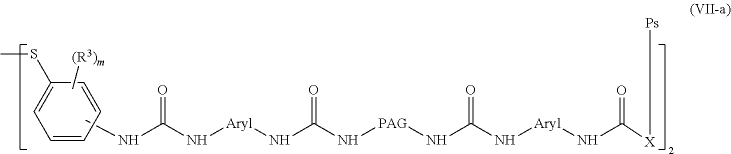

wherein
m can be 0, 1, 2, 3 or 4;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
PAG represents a polyalkylene glycol;
X is O, S or N(R²), wherein each R² is selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl, preferably hydrogen; and
Ps represents a second polymeric chain fragment selected from polyvinyl alcohol or a copolymer thereof.

The compounds of formula (VI-a) and (VII-a) can each constitute aspects of the present disclosure.

The most common disulfide used is 4,4′-diaminophenyl disulfide, and thus m is typically 0 in the formulas (III), (III-a), (IV-a), (V-a), (VI-a) or (VII-a).

For the disulfide-containing self-healing polymers of the disclosure R¹ and R² are preferably selected from the group consisting of hydrogen, C₁-C₂₄-alkyl and C₆-C₁₅-aryl, preferably selected from the group consisting of hydrogen, C₁-C₄-alkyl and C₆-C₁₀-aryl, more preferably hydrogen.

Blends

Blends of the disclosure are prepared following known procedures. They can be prepared by mixing component (i) and component (ii), typically at temperatures that allow a fluid mixture of both. The blending temperature is typically above room temperature (i.e. 15-30° C.), for example comprised between room temperature and 300° C. or between 50° C. and 200° C. The skilled person can adjust the temperature in order to obtain component (i) and component (ii) in a proper fluid state for blending. Blending can also be facilitated by the use of a solvent, which can then be removed from the blend, if necessary.

The blending can be performed in an extruder, a compounding extruder or a compounding chamber, but other installations are also suitable. The proportion between component (i) and component (ii) is not critical. On the one hand, sufficient component (ii) must be incorporated in order to obtain a blend having self-healing properties. On the other hand, as the proportion of component (ii) increases, the properties of the blend may further depart from those of the original thermoplastic host polymer. Thus, in the present disclosure the thermoplastic host polymer, represents between 10 wt % and 99.9 wt %, with respect to the total weight of the blend, and the disulfide-containing self-healing polymer is present between 0.1 wt % and 90 wt %, with respect to the total weight of the blend. Depending of the final properties of the blend required, the skilled person can adjust the proportions between component (i) and component (ii). For example, component (ii) can be present in between 1 wt % and 60 wt %, or between 1 wt % and 40 wt % or between 1 wt % and 30 wt %, or between 1 wt % and 15 wt % or between 10 wt % and 35 wt %, with respect to the total weight of the blend. The properties of the blend of the disclosure provide however surprising variations which could not have been anticipated. For example, the use of the disulfide-containing self-healing polymer in proportions between 5 wt % and 40 wt %, preferably between 5 wt % and 35 wt %, preferably between 5 wt % and 30 wt %, preferably between 5 wt % and 18 wt %, preferably between 5 wt % and 15 wt %, more preferably between 5 wt % and 12 wt %, with respect to the total weight of the blend, maintain or even improve puncture resistance with respect to the un-blended thermoplastic host polymer, as shown in example 7. This result is significant as it means that a low-cost solution to reinforcement, leading to fewer damage events with resulting defects can be envisaged.

The amount of thermoplastic host polymer, can be between 30 wt % and 99.9 wt %, between 40 wt % and 99 wt %, between 45 wt % and 99 wt %, between 50 wt % and 99 wt %, between 55 wt % and 97 wt %, between 60 wt % and 97 wt %, between 65 wt % and 97 wt %, between 70 wt % and 96 wt %, between 75 wt % and 96 wt %, between 80 wt % and 96 wt %, between 82 wt % and 95 wt % or between 88 wt % and 95 wt %, with respect to the total weight of the blend.

The skilled person readily understands that the above ranges can be combined and thus, for example, a typical blend according to the disclosure comprises between 40 wt % and 99 wt % of thermoplastic host polymer and between 1 wt % and 60 wt % of the disulfide-containing self-healing polymer (component (ii)). Further examples are blends comprising between 60 wt % and 99 wt % of thermoplastic host polymer and between 1 wt % and 40 wt % of the disulfide-containing self-healing polymer (component (ii)) or between 70 wt % and 98 wt % of thermoplastic host polymer and between 2 wt % and 30 wt % of the disulfide-containing self-healing polymer (component (ii)) or between 82 wt % and 95 wt % of thermoplastic host polymer and between 5 wt % and 18 wt % of the disulfide-containing self-healing polymer (component (ii)).

For example the blend of the disclosure may comprise an EVA polymer and/or an EBA polymer or a polyolefin (e.g. polypropylene, polyethylene, HDPE, LLPE, LDPE) in amounts between 60 wt % and 99 wt %, with respect to the total weight of the blend, and said component (ii) in amounts between 1 wt % and 40 wt %, with respect to the total weight of the blend.

Further examples of blend are listed below. Each blend cannot be understood as isolated from the rest of the disclosure, and the skilled person understands that each blend listed below can be modified to include embodiments mentioned elsewhere in the present disclosure, such as specific ranges of weight percent or polymeric chains.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer of formula (I) as defined above in amounts between 1 wt % and 40 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer of formula (I-a) as defined above in amounts between 1 wt % and 40 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer of formula (II) as defined above in amounts between 1 wt % and 40 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer of formula (II-a) as defined above in amounts between 1 wt % and 40 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer comprising a residue of formula (III) as defined above in amounts between 1 wt % and 40 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer comprising a residue of formula (III-a) as defined above in amounts between 1 wt % and 40 wt %, for example in amounts between 5 wt % and 35 wt %, or in amounts between 5 wt % and 18 wt %, with respect to the total weight of the blend.
For example the blend of the disclosure may comprise an EVA polymer and/or an EBA polymer and/or a non-polar polyolefin (e.g. polypropylene, polyethylene, HDPE, LLPE, LDPE) in amounts between 60 wt % and 99 wt %, with respect to the total weight of the blend, and disulfide-containing self-healing polymer of formula (IV-a), or of formula (V-a), or of formula (VI-a), or of formula (VII-a), as defined above in amounts between 1 wt % and 40 wt %, with respect to the total weight of the blend.
For example the blend of the disclosure may comprise an EBA polymer or a HDPE in amounts between 60 wt % and 99 wt %, with respect to the total weight of the blend, and disulfide-containing self-healing polymer comprising a residue of formula (III) as defined above in amounts between 1 wt % and 40 wt %, with respect to the total weight of the blend.
For example the blend of the disclosure may comprise an EBA polymer and/or a HDPE in amounts between 60 wt % and 99 wt %, with respect to the total weight of the blend, and disulfide-containing self-healing polymer comprising a residue of formula (III-a) as defined above in amounts between 1 wt % and 40 wt %, for example in amounts between 5 wt % and 35 wt %, or in amounts between 5 wt % and 18 wt %, with respect to the total weight of the blend.

Once the blend has been formed, it is possible to further modify it in order to adapt its physical and chemical properties to the intended final application. For example, the blend can be submitted to further crosslinking, wherein the thermoplastic host polymer already incorporated to the blend is crosslinked, or wherein the thermoplastic host polymer and the disulfide-containing self-healing polymer are crosslinked. The blends of the disclosure can also undergo a certain degree of such crosslinking spontaneously, either shortly after or during blending, or once the blend has been in use for long periods of time.

Other Components of the Blend

The skilled person can choose among a wide variety of additives known in the art, for example, from Encyclopedia of Polymer Science and Engineering, 2nd Ed., vol. 14, p. 327-410 or other reference information.

The compositions of the disclosure may further comprise other additives frequently used in the preparation of polymers. The blends of the disclosure may comprise one or more further additives. Preferably, the blend of the disclosure comprises 0 to 5 wt % of one or more further additives, based on the total weight of the blend. In a particular embodiment, it comprises 0.01 to 5 wt % of one or more further additives, preferably 0.01 to 3 wt. %, more preferably 0.05 to 2 wt. %, even more preferably 0.05 to 0.5 wt. %. Examples of these additives include antioxidants, such as sterically hindered phenols, phosphites, thioethers or thioesters; rheology modifiers (flow agents), such as copolymers of ethylene with vinyl acetate or acrylic acid; stabilizers or antislipping agents, such as amide derivatives; colorants, such as titanium dioxide; fillers, such as talc, clay, silica and calcium carbonate.

The compositions of the disclosure can also comprise as an optional additive 0.005 to 5 wt % of at least one antioxidant, based on the total weight of the adhesive composition, for example, 0.01 to 5 wt % of at least one antioxidant, preferably 0.01 to 3 wt %, more preferably 0.05 to 2 wt %, even more preferably 0.05 to 0.5 wt %. Said antioxidant can be selected from sterically hindered phenols, phosphites and mixtures thereof. Preferably, it is a mixture of a sterically hindered phenol and a phosphite. Sterically hindered phenols are well known to the skilled person in the art and refer to phenolic compounds which contain sterically bulky groups, such as tert-butyl, in close proximity to the phenolic hydroxyl group thereof. In particular, they may be characterized by phenolic compounds substituted with tert-butyl groups in at least one of the ortho positions relative to the phenolic hydroxyl group. Hindered phenols frequently used have tert-butyl groups in both ortho-positions with respect to the hydroxyl group. Representative hindered phenols include pentaerythritol tetrakis(3-(3,5-di-tert-butyl-4-hydroxyphenyl)propionate), 1,3,5-trimethyl-2,4,6-tris(3,5-di-tert-butyl-4-hydroxybenzyl) benzene, n-octadecyl-3(3,5-di-tert-butyl-4-hydroxyphenyl) propionate, 4,4′-methylenebis(4-methyl-6-tert-butylphenol), 4,4′-thiobis(6-tert-butyl-o-cresol), 6-(4-hydroxyphenoxy)-2,4-bis(n-ocytlthio)-1,3,5-triazine, 2,4, 6-tris(4-hydroxy-3,5-di-tertbutyl-phenoxy)-1,3,5-triazine, di-n-octadecyl-3,5-di-tert-butyl-4-hydroxybenzylphosphonate, 2-(n-octylthio)ethyl-3,5-di-tert-butyl-4-hydroxybenzoate, and sorbitol hexa-(3,3,5-di-tert-butyl-4-hydroxy-phenyl) propionate.

Phosphites are preferably aromatically substituted phosphites, preferably substituted or unsubstituted triphenyl phosphites. Examples of these phosphites include triphenyl phosphite, trisnonylphenyl phosphite, and tris(2,4-di-tert butylphenyl)-phosphite.

For example, the composition of the disclosure may comprise 0.05 to 0.5 wt % of at least one antioxidant selected from sterically hindered phenols, aromatically substituted phosphites and mixtures thereof. Preferably, the antioxidant is a mixture of a sterically hindered phenol and an aromatically substituted phosphite, e.g. a mixture of pentaerythritol tetrakis(3-(3,5-di-tert-butyl-4-hydroxyphenyl)propionate) and tris(2,4-di-tert-butylphenyl)-phosphite.

Further additives that can be included in the compositions of the disclosure can be selected from the following:
Stabilizers;
rheology modifiers, also known as flow agents, should the blend formulation require them for optimal processing properties—typically used at loadings of 0.2-2% by weight. These may be selected from a wide range of small molecules, oligomers and polymers compatible with the major blend components—typical flow agents for polyethylenes include ethylene copolymers with vinyl acetate or acrylic acid.
fillers for reducing cost, adding bulk, improving cohesive strength (forming an aggregate-matrix composite material) and altering properties; e.g., calcium carbonate, barium sulfate, talc, silica, carbon black, clays (e.g., kaolin);
UV stabilizers which protect the material against degradation by ultraviolet radiation;
pigments and dyes, e.g. cable-coating dye;
inorganic, organic and polymeric flame retardants and their synergists;
antistatic agents:
ferromagnetic particles, hygroscopic water-retaining materials, or other materials which can yield a composition which can be activated by microwave heating or magnetic induction; and/or
electrically conductive particles which can yield conductive materials for electric charge dissipation and for electric field stress control such as in high voltage cables and cable accessories
biocides for hindering bacterial growth.

Articles of Manufacturing

The blend of the disclosure can be applied, for example, as a tube, a protection surface, a tyre, a package, a leak-tight article, a film, a coating or layer, for example, an electrical cable, an optical fibre cable, or a cable sheath. Typically, in the latter case, the polymer blend is extruded or co-extruded over the cable as the cable is drawn through a die, to form a cable sheath. The blend of the disclosure can also be used as component of adhesive formulations.

Other articles of manufacture that can be prepared from the polymer blends of this disclosure, particularly under high pressure and/or elevated moisture conditions, include fibers, ribbons, sheets, tapes, pellets, tubes, pipes, weather-stripping, seals, gaskets, foams, and footwear. These articles can be manufactured using known equipment and techniques.

A number of exemplary methods for preparing the components and the blends of the present disclosure are provided below. These methods are intended to illustrate the nature of such preparations. They are not intended to limit the scope of applicable methods. Generally, the reaction conditions such as temperature, reaction time, solvents, work-up procedures, and the like, will be those common in the art for the particular reaction. The cited reference material, together with material cited therein, contains detailed descriptions of such conditions. The work-up and purification techniques used are those common in the field of polymer chemistry.

### EXAMPLES

### Glossary of Terms

“w.r.t” is the abbreviation for “with respect to”.

EVA: EVA ALCUDIA® PA-440 (28% VA), EVA ALCUDIA® PA-470 (40% VA)

EBA: EBA ALCUDIA® PA803C (8% BA), EBA ALCUDIA® PA-27003 (27% BA)

PE: ALCUDIA 3235FG (low density PE), ALCUDIA® C-220 (high-density PE)

PE-g-MAH. OREVAC® 18302N (maleic anhydride modified linear low-density polyethylene)

Polypropylene glycol: PPG-diisocyanate=2,300 gmol⁻¹, based on PPG of 2,000 gmol⁻¹

### Example 1: Preparation of Disulfide-Containing Self-Healing Polymer of Formula (1)

The disulfide-containing self-healing polymer of formula (1) used in the blends of the disclosure was prepared according to the following procedure.

The poly(propylene oxide)-diisocyanate of formula (2) (2,300 gmol⁻¹; 27.78 g, 12.08 mmol) and 4-aminophenyldisulfide (3) (3.00 g, 12.08 mmol) were added to a round-bottom flask with a stirrer bar. The poly(propylene oxide)-diisocyanate of formula (2) was purchased, but it can also be prepared by reacting 2,4-toluenediisocyanate (TDI) with polypropylene glycol under known conditions. The flask was placed under reduced pressure and heated to 60° C. to reduce the viscosity of the contents. The reaction mixture was stirred at 60° C. for 24 h, whereupon viscosity increase in the transparent yellow liquid led to arrest of the stirring. Over the course of 24 h at room temperature, the reaction mixture gradually solidified to yield the disulfide-containing self-healing polymer of formula (1) as a transparent, yellow rubbery solid. Yield >99% (w.r.t. polypropylene diisocyanate of formula (2)) estimated due to elimination of isocyanate absorption band in the FTIR spectrum.

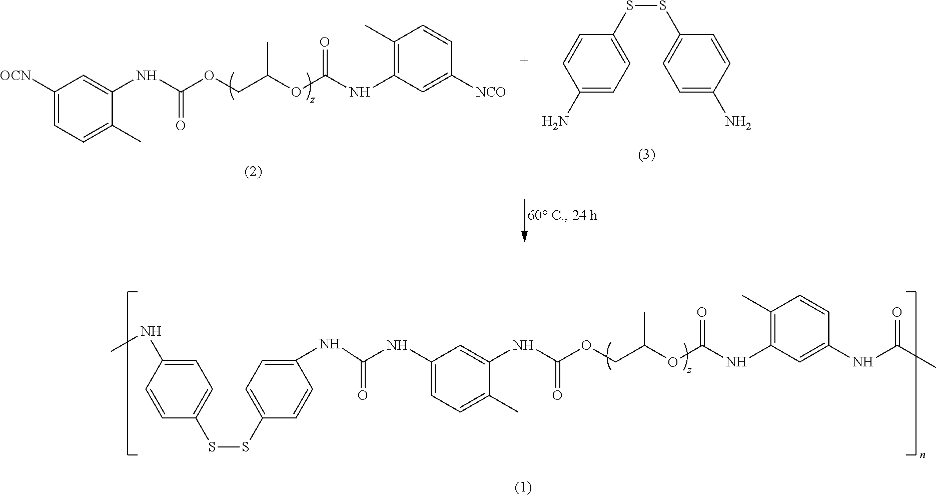

“n” has the same meaning as in other parts of the present disclosure (e.g. see meaning of n in compounds of formula (IV-a) or (V-a)).

“z” is a number representing 1 or more

### Example 2: Preparation of Disulfide-Containing Self-Healing Polymer of Formula (4)

The disulfide-containing self-healing polymer of formula (4) used in the blends of the disclosure was prepared according the following procedure.

Poly(ethylene-co-vinyl alcohol) (EVOH) was prepared from poly(ethylene-co-vinyl acetate) (EVA) by basic hydrolysis. In a typical synthesis, a 1 L single necked round bottomed flask was charged with 50 g of EVA and 500 mL of tetrahydrofuran. The mixture was stirred for a couple of hours to achieve a homogeneous solution. 1 Equivalent (w.r.t estimated VA content) methanolic sodium hydroxide solution was added slowly into the reaction mixture with vigorous stirring. Once addition was complete, the reaction mixture was stirred under reflux conditions for 12 h. The reaction mixture was allowed to cool, then neutralised by the addition of 1M aqueous hydrochloric acid solution with continuous stirring. The pH of the reaction mixture was monitored until pH 7 was reached. The neutral reaction mixture was precipitated by addition to 1 L of cold water. The solids were collected by filtration, then washed with water (3×200 mL) then methanol (2×100 mL). The product was also washed with pentane then dried in vacuo for 12 hours, furnishing an off-white solid product (Yield=88%).

Polyethylene Grafted with Polypropylene Glycol Isocyanate (6)

Preparation of PE-g-PPG-DS (4)

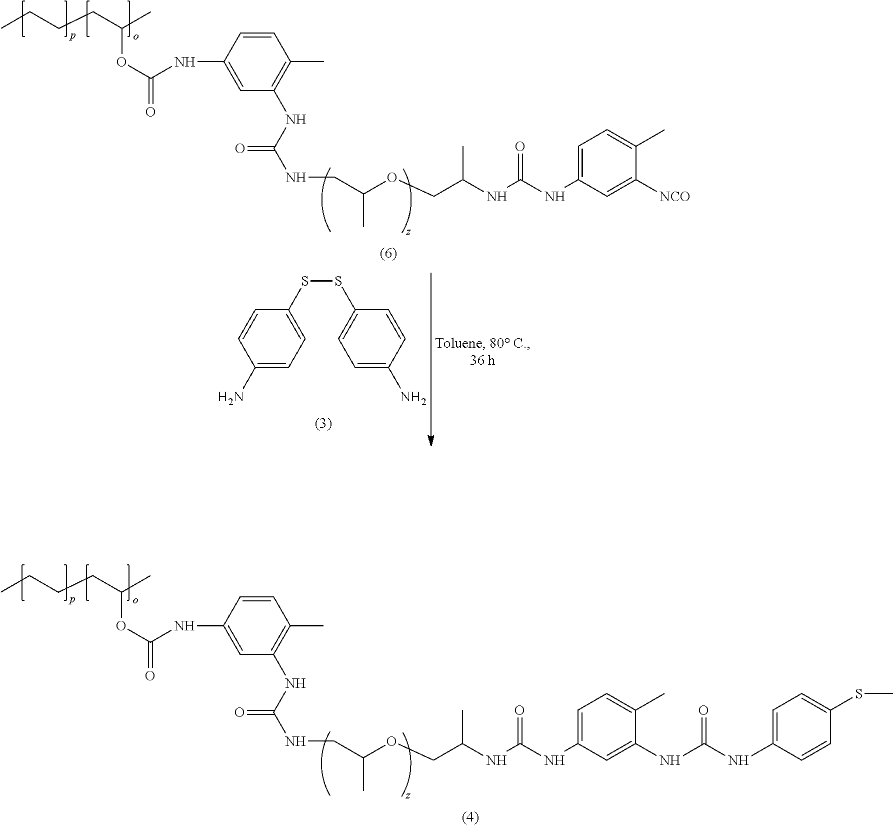

### Example 3: Blends

To a twin-screw compounder at a temperature between 120° C. and 160° C. was added the thermoplastic host polymer and the polymer blended for 5 min at 20 rpm to obtain a homogeneous melt. The compounder was then purged with nitrogen to obtain an inert atmosphere. The disulfide-containing self-healing polymer was added (total wt % 10-50%) in approximately 0.5 g portions over a period of 1-2 minutes, then the nitrogen atmosphere was reapplied and the blending recommenced at 120° C., 140° C. or 160° C. and 100 rpm. Thus, the blends in this example contained only the disulfide-containing self-healing polymers used in the present disclosure (component (ii)) and the thermoplastic host polymer (component (i)). Small amounts of antioxidants (500-1,000 ppm by weight) were added. After 15 minutes the reactor was allowed to cool under nitrogen purge and the product, (usually a translucent yellow solid), was extracted and pelletized, for further processing and characterization. Good dispersion of the disulfide-containing self-healing polymer was confirmed in all cases by transmission and reflectance microscopy.

The blends prepared are summarized in Table 1 below. All blends include 500-1,000 ppm by weight of antioxidant.

TABLE 1

| | | | Wt % | |
|---|---|---|---|---|
| | | | disulfide- | |
| | | | containing | |
| | Disulfide- | | self-healing | |
| | containing self- | Thermoplastic | polymer of | Wt % |
| Blend No. | healing polymer | host polymer | formula (4) | polymer |
| Blend (1) | (1) | EBA PA803C | 10 | 90 |
| Blend (2) | (1) | EBA PA803C | 30 | 70 |
| Blend (3) | (1) | LDPE | 15 | 85 |
| | | 3235FG | | |
| Blend (4) | (1) | EVA PA-440 | 10 | 90 |
| Blend (5) | (1) | EVA PA-440 | 30 | 70 |

For all proportions tested of thermoplastic host polymer and disulfide-containing self-healing polymer, homogeneous blends were obtained as indicated by visual inspection and confirmed by obtaining Raman Spectra at different points in the blend.

Following analogous procedures, we prepared blends based on high density polyethylene (HDPE), ethylene vinyl acetate (EVA) and maleic anhydride grafted polyethylene (PE-g-MA). The proportions in each case are indicated in Table 2 below. The proportions of each component are given in parts per weight.

TABLE 2

| | | | | | Disulfide- |
|---|---|---|---|---|---|
| | | | | | containing self- |
| | | EVA | EVA | | healing polymer |
| Blend No. | HDPE | 40 | 28 | PE-g-MA | of formula (4) |
| Control | 7 | 2 | | 1 | |
| Blend (6) | 4 | 2 | | 1 | 3 |
| Blend (7) | 4 | 3 | | 1 | 2 |
| Blend (8) | 5 | 2 | | 1 | 2 |
| Blend (9) | 7 | 2 | | 1 | 2 |
| Blend (10) | 4 | | 3 | 1 | 2 |
| Blend (11) | 8 | 3 | 3 | 2 | 4 |
| Blend (12) | 9 | 5 | | 2 | 5 |
| Blend (13) | 9 | 4 | | 3 | 4 |

A further set of blends were prepared following analogous procedures. Their proportions in parts by weight are given below in Table 2A:

| | | | | | Disulfide- |
|---|---|---|---|---|---|
| | | | | | containing self- |
| | EBA | EBA | EVA | EVA | healing polymer |
| Blend No. | 13 | 27 | 28 | 33 | of formula (4) |
| Blend (14) | 8 | | | | 2 |
| Blend (15) | 7 | | | | 3 |
| Blend (16) | | 8 | | | 2 |
| Blend (17) | | 7 | | | 3 |
| Blend (18) | | | 8 | | 2 |
| Blend (19) | | | 7 | | 3 |
| Blend (20) | | | | 8 | 2 |
| Blend (21) | | | | 7 | 3 |

The water barrier properties of these blends are discussed in Examples 6-8 below.

### Example 4: Self-Healing Properties of the Blends—Cut-and-Heal Test

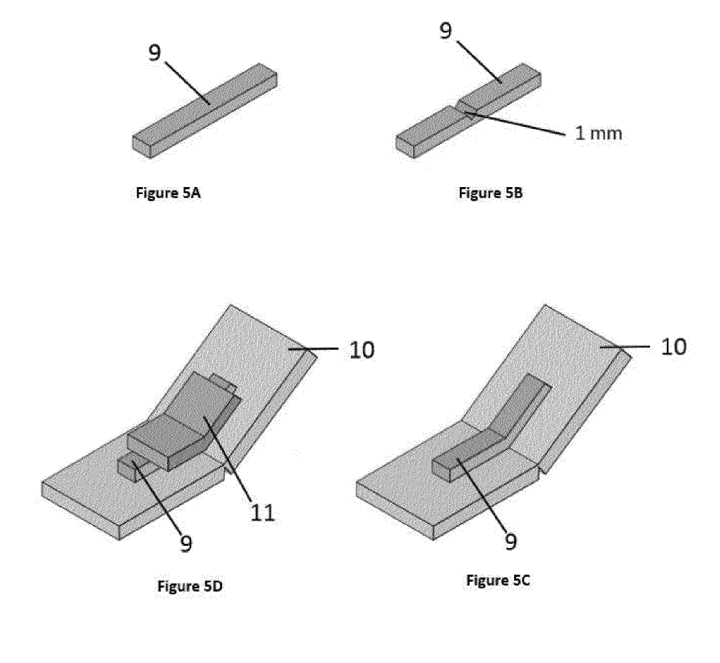

As shown in FIGS. 5A, 5B, 5C and 5D, samples (9) were cast 2 mm thick (FIG. 5A) and then cut to a depth of 1 mm (50% bisection) across the width of the sample, halfway along the length (FIG. 5B). The healing condition for the samples involved placement on a cantilever surface (a flat, horizontal section and a section inclined at 50) (10), with the cut located at the joint, parallel to the articulation (FIG. 5C). This acts to promote contact of the damaged surfaces. A load (100 g) (11) was placed upon both the horizontal and inclined sections of the samples to constraint deformation and ensure contact between damaged regions was maintained between the surfaces (FIG. 5D). Samples were then placed in an oven at 70° C. to allow self-healing to take place. After being allowed to self-heal, self-healing efficiency of samples was assessed via tensile testing: Overall, healing efficiency was determined by comparing the recovery of tensile strength of the healed samples with the recovery of samples which were freshly cut to a depth of 1 mm (effectively, 0% recovery) and intact samples. The following formula was used to quantify healing efficiency:

Healing Efficiency (%)=(Tensile strength of Healed sample at 70° C., 24 h−Tensile strength of 1 mm freshly cut sample)/(Tensile strength of intact sample−Tensile strength of 1 mm freshly cut sample)×100

The results are shown below in Table 3.

TABLE 3

| | Tensile | Tensile |
|---|---|---|
| | strength Blend (1) | strength Blend (2) |
| | (MPa) | (MPa) |
| Intact | 9.9 | 6.9 |
| 1 mm freshly cut | 4.3 | 2.4 |
| Healed 70° C., 24 h | 4.9 | 2.6 |
| Healing efficiency (%) | 11 | 4.2 |

As it happened with the thermoplastic host polymer, the introduction of a 1 mm cut in the blends of the disclosure resulted in a substantial reduction in maximum stress (4.3 MPa in Blend (1) and 2.4 MPa in Blend (2)). However, after 24 hours incubation, it is shown that samples demonstrate a not-insignificant recovery, with maximum stress increasing to 4.9 MPa for Blend (1) and to 2.6 MPa for Blend (2). This represents a 11% and 4.2% recovery, respectively of tensile strength, sufficient to indicate that tangible self-healing is in operation despite the presence of the edge notch in this type of sample.

### Example 5: Self-Healing Properties of the Blends—Water Barrier Test

The ability of blends to recover water barrier ability, as an indication of widely applicable, functional self-healing, was tested using one or more curing (or healing) conditions (see Tables 4 and 5). These tests are described below with reference to figures, 1, 2, 3 and 4.

Preparation of Test Specimens

Polymer or polymer blend test specimens (2) of circular shape, 25 mm in diameter and 1.0 mm thick were used for testing the recovery of the water barrier abilities of the materials—any method that produces specimens of representative composition across the specimen, with consistent diameter (a guideline tolerance would be +/−2.5 mm) and thickness (+/−0.2 mm) is suitable for the test. The results presented herein derived from specimens formed by constrained die-pressing at temperatures between 120° C. and 200° C., to 1 mm thickness, then sampling using a punch-die of 25 mm diameter.

The specimen was punctured centrally using a 19 gauge needle (1.1 mm OD) to a depth of 2 mm, then either tested for its water barrier ability immediately or subjected to a healing condition prior to testing.

Healing Conditions

Damaged test specimens (2) in the form of discs were placed between 2 thermally conductive sheets (typically steel of 1 mm thickness) in order to prevent specimen deformation during healing. The specimens were heated to a temperature of between 25° C. and 70° C. for a period of between 24 hours and 20 days, then cooled to ambient temperature and subjected to testing within 24 h.

Water Barrier Test Operation

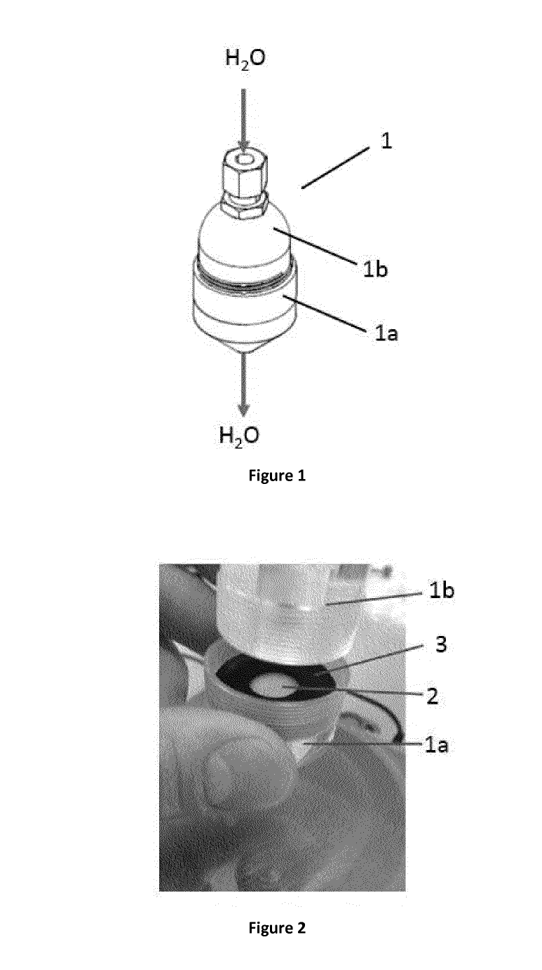

The test specimen (2) was placed in the lower portion (1a) of one of the four sample chambers (1) (these chambers are depicted in FIGS. 1 and 2) of the purposely designed water barrier test apparatus. As shown in FIG. 2, the test specimen (2) was restrained by neoprene gaskets (3). The sample chambers (1) were assembled (the lower portion (1a) and the upper portion (1b) were screwed together in order to close the chamber) to seal all but the central 15 mm diameter circular portion of the test specimen (2).

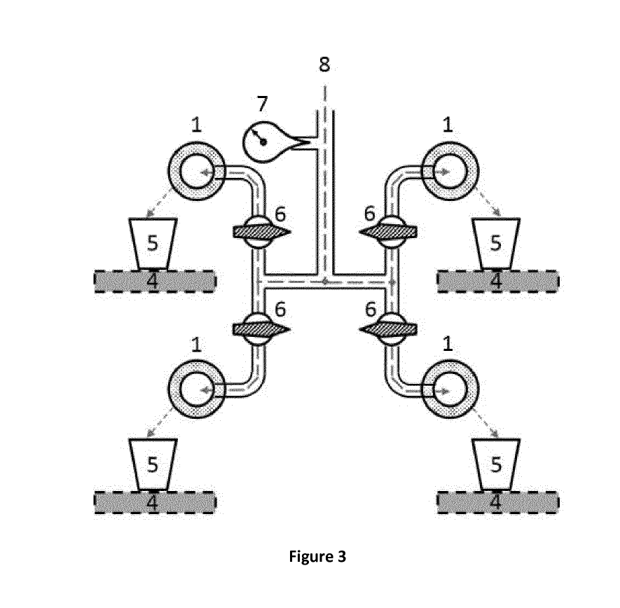

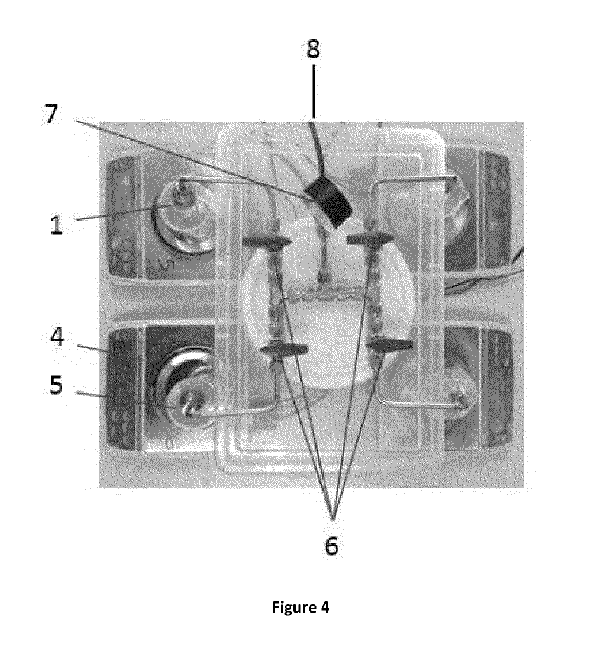

The water barrier test apparatus (see FIGS. 3 and 4) includes a pressure-controlled water inlet (8) (a vessel part-filled with water and pressure-regulated compressed air inlet, with water outlet via high pressure tubing), a pressure gauge (7) and branches (stainless steel tubing and compression fittings) leading to the four sample chambers (1) (acrylic resin to visualize the process). Each branch features an isolation valve (6). The apparatus is designed to deliver a pressure-regulated water head to the sample chambers, whereby water may only flow out of the apparatus via the sample chambers (1) through a defect in the sample. Water that exits the apparatus is collected in catchment cups (5) below the sample chambers (1), where the catchment cups (5) are placed on balances (4) that record water flow by mass collected per unit time.

In a typical test, up to three of the chambers (1) are loaded with damaged or self-healed test specimens (2) for testing, the fourth sample chamber (1) is loaded with a control of an intact polymer disc. The test specimen (2) within the sample chamber (1) is aligned such that the direction of water flow matches the direction of needle penetration during sample preparation, to avoid pressure-induced defect closure. Every sample chamber (1) is located above the catchment cup (5) placed on the balance (4) in order to retain and weigh all the water that may pass through the sample (see FIGS. 3 and 4). For this, the four sample chambers (1) were charged simultaneously with water and pressurized to a known pressure (1.0 or 2.0 bar above atmospheric pressure). The ambient temperature, including water storage conditions, in the test location had a range of 20-25° C., and atmospheric pressure typically 0.95-1.05 bar. Water flow through the defect zone was measured by mass collected in the catchment cup (5) per unit of time. Water barrier recovery was established by the total absence of water flow through damaged or damaged and self-healed test specimens (2) for a specified time period, typically 5 minutes.

The test was repeated for a minimum of three test specimens (2) per sample to ensure consistent healing action was identified.

Confirmation of damage or visualization of damage zones before and/or after water barrier testing or healing conditions can typically be achieved by high-resolution optical microscopy.

Results

The results are summarized below in Table 4 and Table 5. It is remarkable that all blends according to the disclosure provided water barrier both, shortly (24 h) after puncture (except blend 9) and/or after further time (20 days) allowed to self-heal. It is already known that disulfide-containing polymers can display self-healing properties, but is surprising that the disulfide-containing self-healing polymers used in the blends of the disclosure are readily compatible with thermoplastic host polymers. It is further surprising that even small amounts of disulfide-containing polymers impart to the blends according to the disclosure very rapid self-healing abilities.

TABLE 4

| | | Water barrier |
|---|---|---|
| | | 24 h |
| | | 70° C. |
| Blend No. | Components | 1 bar |
| EBA | — | NO |
| Disulfide containing | — | YES |
| self-healing polymer of | | |
| formula (1) | | |
| Blend (1) | EBA/Self-healing | YES |
| | 9/1 | |
| Blend (2) | EBA/Self-healing | YES |
| | 7/3 | |
| Blend (3) | LDPE/Self-healing | YES |
| | 85/15 | |

TABLE 5

| | | 24 h | 24 h | 20 days |
|---|---|---|---|---|
| | | 70° C. | 70° C. | 70° C. |
| Blend No. | Components | 1 bar | 2 bar | 1 bar |
| Control | HDPE/EVA40/PE-g-MA | NO | NO | NO |
| | 7/2/1 | | | |
| Blend (6) | HDPE/EVA40/PE-g- | YES | YES | YES |
| | MA/Self-healing (4) | | | |
| | 4/2/1/3 | | | |
| Blend (7) | HDPE/EVA40/PE-g- | YES | YES | YES |
| | MA/Self-healing (4) | | | |
| | 4/3/1/2 | | | |
| Blend (8) | HDPE/EVA40/PE-g- | YES | Not | YES |
| | MA/Self-healing (4) | | Measured | |
| | 5/2/1/2 | | | |
| Blend (9) | HDPE/EVA40/PE-g- | NO | Not | YES |
| | MA/Self-healing (4) | | Measured | |
| | 7/2/1/2 | | | |
| Blend (10) | HDPE/EVA28/PE-g- | YES | Not | YES |
| | MA/Self-healing (4) | | Measured | |
| | 4/3/1/2 | | | |

It is remarkable that all blends according to the disclosure provided water barrier recovery thanks to their self-healing ability

### Example 6: Self-Healing Properties of the Blends—Water Barrier Test of Tap Water and Sea Water

The water barrier properties towards tap water of blends (14) to (21) was tested under analogous conditions, but considering different healing times at 70° C. and 1 bar. The results are shown below in Table 6. In each case “YES” means that the sample completely healed in the time given and no water could be collected, the water barrier being thus complete.

TABLE 6

| | 1 | 10 | 1 | 30 | 1 |
|---|---|---|---|---|---|
| Blend No. | day | hours | hour | minutes | minute |
| Blend (14) | YES | YES | YES | YES | NO |
| Blend (15) | YES | Not | YES | YES | YES |
| | | Measured | | | |
| Blend (16) | YES | YES | YES | YES | YES |
| Blend (17) | YES | Not | YES | YES | YES |
| | | Measured | | | |
| Blend (18) | YES | YES | YES | YES | NO |
| Blend (19) | YES | Not | YES | YES | YES |
| | | Measured | | | |
| Blend (20) | YES | Not | YES | YES | YES |
| | | Measured | | | |
| Blend (21) | YES | Not | YES | YES | YES |
| | | Measured | | | |

The water barrier properties towards tap water of blends (14) to (17) was tested under analogous conditions, but considering different healing times at 30° C. and 1 bar. The results are shown below in Table 7. In all cases total water barrier protection was observed.

TABLE 7

| | 5 | 1 | 10 |
|---|---|---|---|
| Blend No. | days | day | hours |
| Blend (14) | YES | YES | YES |
| Blend (15) | YES | YES | YES |
| Blend (16) | YES | YES | YES |
| Blend (17) | YES | YES | YES |

Finally, the water barrier properties towards sea water (35 g/L of NaCl) of blends (14) to (21) was tested under analogous conditions, but considering healing times of 30 minutes and 1 hour at 70° C. and 1 bar, and healing times of 1 day and 5 days at 30° C. and 1 bar. In none of the cases water was collected, indicating total water barrier protection.

### Example 7: Self-Healing Properties of the Blends—Multiple Cycles of Water Barrier

In these examples we wanted to test the number of cycles the blends of the disclosure could stand without losing water barrier properties. In all cases analogous conditions were used for measuring water barrier. In a first cycle the sample was punctured as in examples 5 or 6, and then allowed to rest for a specified time, after which its water barrier properties were measured. Then, in a second cycle, the sample was punctured again on the same spot, allowed to rest for the specified time and its water barrier properties measured. In case of a successful second cycle, a third cycle was conducted. The results are shown in Table 8. In each case “YES” means that the sample completely healed in the time given and no water could be collected, the water barrier being thus complete.

TABLE 8

| | Cycle 1 | | Cycle 2 | | Cycle 3 | |
|---|---|---|---|---|---|---|
| | 1 | 5 | 1 | 5 | 1 | 5 |
| Blend | minute | hours | minute | hours | minute | hours |
| No. | 70° C. | 30° C | 70° C. | 30° C. | 70° C. | 30° C. |
| Blend | YES | YES | YES | YES | YES | NO |
| (17) | | | | | | |
| Blend | YES | YES | NO | YES | Not | NO |
| (19) | | | | | Measured | |
| Blend | YES | YES | NO | YES | Not | NO |
| (21) | | | | | Measured | |

We could conclude that, given sufficient time, the blends of the disclosure could withstand several puncture/healing cycles without losing water barrier properties.

### Example 8: —Mechanical Properties of the Blends—Resistance to Puncture

Resistance to puncture was evaluated using a Zwick/Roell 5 kN Universal Testing Instrument fitted with a penetrator attachment. The test evaluates the maximum resistive force divided by the sample thickness (Fmax/thickness). Comparative results are given as a percentage of the value obtained for the blend related to the value for the pure thermoplastic host polymer. This property is of high interest for applications in which the material is employed as a protective barrier against puncture damage (e.g. many kinds of packaging, pipes, cable sheaths, and others). The combination of this and the self-healing properties of the materials can be of great value for these applications as further promoting its protective characteristics.

The results are summarized below (Table 9), highlighting their standardized resistance to puncture (units N/mm), together with the coefficient of variance, v (%). In addition to the surprisingly fast self-healing behavior, it was even more unexpected the finding that blending with the disulfide-containing self-healing polymers described in the present disclosure, maintained or even improved the resistance to puncture of the blend with respect to the un-blended thermoplastic host polymer. See in Table 9 the resistance to puncture of EBA (197 N/mm) as compared to blend (2) (193 N/mm, almost unchanged) or blend (1) (247 N/mm, i.e. 125% improvement). The fact that the resistance to puncture of the disulfide-containing self-healing polymer is typically much lower than that of the thermoplastic host polymer, e.g. 78 N/mm for disulfide-containing self-healing polymer of formula (1), indicates an unexpected synergistic reinforcement effect between thermoplastic host polymers (component (i)) and disulfide-containing self-healing polymers comprising a first polymeric chain fragment comprising one or more disulfide moieties and at least one moiety selected from the group consisting of polyurethanes, polycarbamates and polythiocarbamates (component (ii)). This result is significant as it means that a low-cost solution to reinforcement, leading to fewer damage events with resulting defects can be envisaged.

TABLE 9

| | Resistance to | |
|---|---|---|
| | puncture | Comparative |
| Sample | (N/mm) (v %) | values |
| EBA | 197 (7.2) | — |
| Disulfide | 78 | |
| containing self-healing | | |
| polymer of formula (1) | | |
| Blend (1) | 247 (6.0) | 125% |
| Blend (2) | 193 (4.3) | 98% |

1. A blend comprising
(i) between 10 wt % and 99.9 wt %, with respect to the total weight of the blend, of a thermoplastic host polymer, provided it is not a polyborosiloxane; and
(ii) between 0.1 wt % and 90 wt %, with respect to the total weight of the blend, of a disulfide-containing self-healing polymer comprising a first polymeric chain fragment comprising one or more disulfide moieties and at least one moiety selected from the group consisting of —N(R¹)—C(═O)—N(R²)—, —N(R¹)—C(═O)—O— and —N(R¹)—C(═O)—S—, wherein each R¹ and R² is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

2. The blend according to claim 1, wherein said disulfide-containing self-healing polymer comprises an aromatic disulfide.

3. The blend according to claim 1, wherein said first polymeric chain fragment comprises one or more polymeric units selected from the group consisting of polyalkylene glycols, formaldehyde phenolic resins, celluloses, polyhydroxystyrenes, polyvinyl alcohol or copolymers thereof.

4. The blend according to claim 3, wherein said first polymeric chain fragment comprises a polyalkylene glycol.

5. The blend according to claim 1, wherein said thermoplastic host polymer is selected from the group consisting of polyolefins, polyalkylene glycols, polyestyrenes, fluoropolymers, polyvinyl chlorides, polycarbonates, polybenzimidazoles, polyamides, polylactic acid, rubbers, (meth)acrylates and copolymers thereof.

6. The blend according to claim 1, wherein said thermoplastic host polymer is a polyolefin selected from the group consisting of EVA, EBA, polyethylene and mixtures thereof.

7. The blend according to claim 1, wherein the amount of said disulfide-containing self-healing polymer is between 5 wt % and 18 wt %, with respect to the total weight of the blend, and the amount of thermoplastic host polymer is between 82 wt % and 95 wt %, with respect to the total weight of the blend.

8. The blend according to claim 1, wherein said
disulfide-containing self-healing polymer comprises a polymeric chain fragment of the following formula (I) or is a polymer of formula (II)
(-[L¹-S—S-L¹]_{y}-U¹-)ₓ (I)
Ps-(L²-U¹-[L¹-S—S-L¹]_{y}-U¹-L²-)_{q}Ps (II)
wherein
x is an integer representing 1 or more;
q is an integer representing 1 or more;
y is an integer representing 1, 2, 3 or 4;
Ps is a polymeric chain;
each L¹ is independently an organic moiety comprising one or more residues selected from the group consisting of —N(R¹)—C(═O)—N(R²)—, —N(R¹)—C(═O)—O— and —N(R¹)—C(═O)—S—, and one or more of the following residues selected from the group consisting of C₆-C₁₅-aryl, C₆-C₁₅-heterocyclyl and C₁-C₂₄-alkyl;
each U¹ is independently a polymer selected from the group consisting of polyalkylene glycols, poly (meth)acrylates, polyesters, polycaprolactones, and polyvinyl alcohol; each U¹ being linked to the same or different further U¹ units through y number of groups of formula [L¹-S—S-L¹-]
each L² is independently an organic moiety comprising one or more residues selected from the group consisting of —N(R¹)—C(═O)—N(R²)—, —N(R¹)—C(═O)—O— and —N(R¹)—C(═O)—S—, and one or more of the following residues selected from the group consisting of aryl, heterocyclyl and alkyl;
wherein each R¹ and R² are independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

9. The blend according to claim 1, wherein said
disulfide-containing self-healing polymer comprises a polymeric chain fragment of the following formula (I-a) or is a polymer of formula (II-a)
(-L¹-S—S-L¹-U¹)ₓ— (I-a)
Ps-(L²-U¹-L¹-S—S-L¹-U¹-L²)_{q}-Ps (II-a)
wherein
x is an integer representing 1 or more;
q is an integer representing 1 or more;
Ps is a polymeric chain
each L¹ is independently an organic moiety comprising one or more residues selected from the group consisting of —N(R¹)—C(═O)—N(R²)—, —N(R¹)—C(═O)—O— and —N(R¹)—C(═O)—S—, and one or more of the following residues selected from the group consisting of C₆-C₁₅-aryl, C₆-C₁₅-heterocyclyl and C₁-C₂₄-alkyl;
each U¹ is independently a polymer selected from the group consisting of polyalkylene glycols, poly (meth)acrylates, polyesters, polycaprolactones, and polyvinyl alcohol;
each L² is independently an organic moiety comprising one or more residues selected from the group consisting of —N(R¹)—C(═O)—N(R²)—, —N(R¹)—C(═O)—O— and —N(R¹)—C(═O)—S—, and one or more of the following residues selected from the group consisting of aryl, heterocyclyl and alkyl;
wherein each R¹ and R² are independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl.

10. The blend according to claim 1, wherein said disulfide-containing self-healing polymer comprises at least one polymeric chain fragment of formula (III) 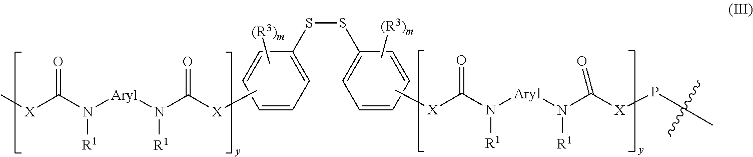
wherein
m can be 0, 1, 2, 3 or 4;
y is 1, 2, 3 or 4;
each R¹ is independently selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl;
P is a polymeric chain fragment selected from the group consisting of polyalkylene glycols, formaldehyde phenolic resins, celluloses, polyhydroxystyrenes, polyvinyl alcohol or copolymers thereof, each P being linked to the same or different further P units through y number of groups;
each X is independently selected from —O—, —O-alkyl-O—, —S—, S-alkyl-S— or —N(R²)—, wherein each R² is selected from the group consisting of hydrogen, C₁-C₂₄-alkyl, C₃-C₂₄-cycloalkyl, C₃-C₂₄-cycloalkyl-C₁-C₂₄-alkyl, C₄-C₂₀-heterocyclyl, C₆-C₁₅-aryl-C₁-C₂₄-alkyl and C₆-C₁₅-aryl

11. The blend according to claim 1, wherein said disulfide-containing self-healing polymer comprises a polymeric chain fragment of formula (V-a) 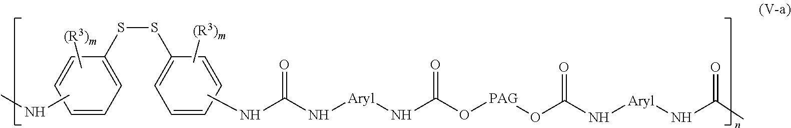
wherein
m can be 0, 1, 2, 3 or 4;
n is 1 or more;
each R³ is independently selected from the group consisting of C₁-C₂₀-alkyl, C₆-C₁₅-aryl, —OR⁴, —(CO)R⁵, —O(CO)R⁶, —(SO)R⁷, —NH—CO—R⁸, —COOR⁹, —NR¹⁰R¹¹, —NO₂, and halogen, wherein R⁴ to R¹¹ are the same or different, and are selected from the group consisting of: —H, C₁-C₂₀-alkyl, and C₆-C₁₅-aryl; and
PAG represents a polyalkylene glycol.

12. The blend according to claim 1, wherein the thermoplastic host polymer and the disulfide-containing self-healing polymer are crosslinked.

13. An article comprising the polymer blend as defined in claim 1.
